(19) United States
(12) Patent Application Publication
(10) Pub. No.: US 2009/0158439 A1
(43) Pub. Date: Jun. 18, 2009

(54) METHOD FOR PROTECTING UNPROTECTED CONTENT IN DRM AND DEVICE THEREOF

(76) Inventors: Seung-Jae Lee, Seoul (KR); Te-Hyun Kim, Gyeonggi-Do (KR); Youn-Sung Chu, Seoul (KR); Kiran Kumar Keshavamurthy, Gyeonggi-Do (KR)

Correspondence Address: BIRCH STEWART KOLASCH & BIRCH, PO BOX 747, FALLS CHURCH, VA, 22040-0747, US

(21) Appl. No.: 12/295,840

(22) PCT Filed: Apr. 10, 2007
(86) PCT No.: PCT/KR2007/001735

§ 371 Date: Oct. 2, 2008

(30) Foreign Application Priority Data
Apr. 11, 2006 (KR) 10-2006-0032977

(51) Int. Cl. G06F 17/00

(52) U.S. Cl. 726/26

(57) ABSTRACT

A method for protecting unprotected content in digital rights management (DRM) and a device thereof. When non-protected content stored in a non-DRM device is to be transferred to a DRM device, the non-protected content are converted into protected content and then are transferred to other user's device.

### DISCLOSURE OF INVENTION

### Technical Solution

This disclosure relates to a digital rights management (DRM), and more particularly, to a method for protecting unprotected content in a DRM and a device thereof.

Generally, a digital rights management (DRM) is technique to protect a rights object (RO) for digital contents and systematically manage it, and provides a protecting and managing system in which serves to prevent an illegal copy of the contents, obtain the RO, creat/move the contents, and consume the RO and the contents.

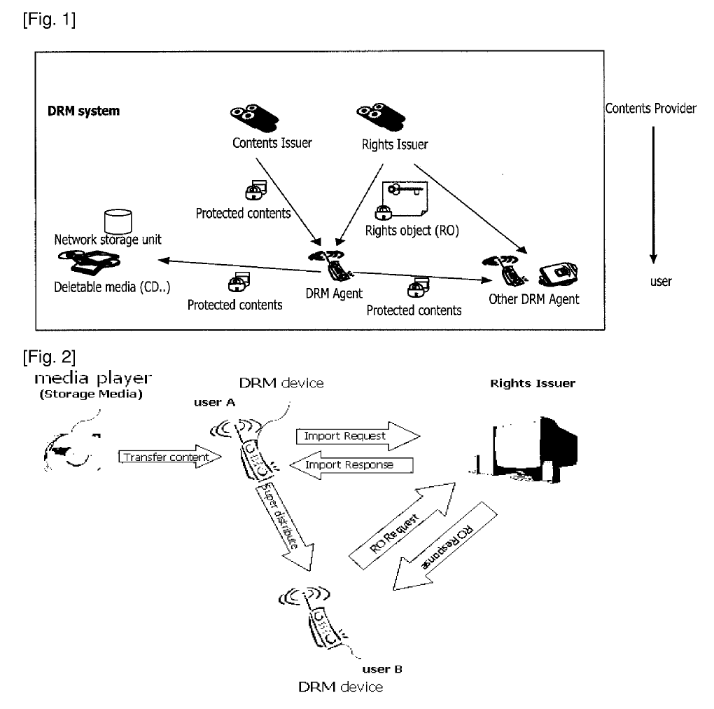

FIG. 1 is a configuration view showing a DRM device in accordance with the related art. As shown, the DRM device controls contents issued to a user by a contents provider to be consumed only within a range of an RO permitted (allocated or authorized) to the user. The contents provider is an entity corresponding to a Contents Issuer (CI) or a Rights Issuer (RI).

The CI issues contents with an encryption (hereinafter, will be referred to as DRM contents) to thereby protect contents from illegal usage by a user having no access right. And the RI issues a Rights Object (RO) necessary to consume the DRM contents.

A DRM Agent is mounted on (equipped with) a DRM device (or a terminal) thus to receive the DRM contents and RO from the CI or the RI, and controls a consumption of the DRM contents by converting into a usable format at a corresponding device by analyzing a ‘License’ contained in the RO.

The RO for the DRM contents may include many kinds of constraints, e.g., the number of times that corresponding contents are consumed, time, a period, or a device.

A user sometimes needs to transfer specific contents, i.e, unprotected contents stored

in a non-DRM device to a user of the non-DRM device after converting into protected contents. Herein, required is a method for transferring the unprotected contents inside the non-DRM device to the DRM device and then converting the unprotected contents into protected contents.

Therefore, this disclosure is to make (convert) unprotected contents into protected contents, and to provide a method and a device thereof.

This disclosure is also to select a specific rights issuer (RI) to provide information required in making (converting) unprotected contents into protected contents and connecting the selected RI to a DRM device, and to provide a method and device thereof.

To achieve these and other advantages and in accordance with this disclosure, as embodied and broadly described herein, there is provided a method for protecting unprotected content, comprising: extracting information from first content stored in a first device by a second device; checking whether an RI URL is included in the extracted information by the second device; and selecting a specific RI and connecting thereto by the second device, if the RI URL is not included in the information.

Preferably, the selecting includes: connecting to a specific network by the second device; searching (browsing, or monitoring) an RI URL list provided from the specific network; selecting a specific RI URL from the RI URL list by a user of the second device; and connecting to an RI corresponding to the selected specific RI URL by the second device.

The method for protecting unprotected content according to the present invention further comprises converting the first content into second content.

The converting includes: receiving a trigger message from the RI by the second device; sending (transferring, or delivering, or forwarding) a request message for encoding the first content to the RI by the second device; sending (transferring, or delivering, or forwarding) a response message to the second device by the RI; and converting (changing, or making) the first content into second content by using specific information included in the response message by the second device.

The method for protecting unprotected content according to the present invention further comprises sending (moving, or transferring, or distributing) the second content to a third device by the second device.

To achieve these and other advantages and in accordance with the purpose of the present invention, as embodied and broadly described herein, there is provided a device for protecting unprotected content, in which whether or not content received from a specific device are protected content is checked (analyzed, or determined), and if the content are unprotected content, the device is connected to a specific network so as to convert the unprotected content into protected content.

Preferably, the device is connected to the specific network thus to receive an RI list therefrom.

Preferably, the device is connected to a specific RI selected from the RI list by a user.

FIG. 1 is a configuration view showing a digital rights management (DRM) device in accordance with the related art;

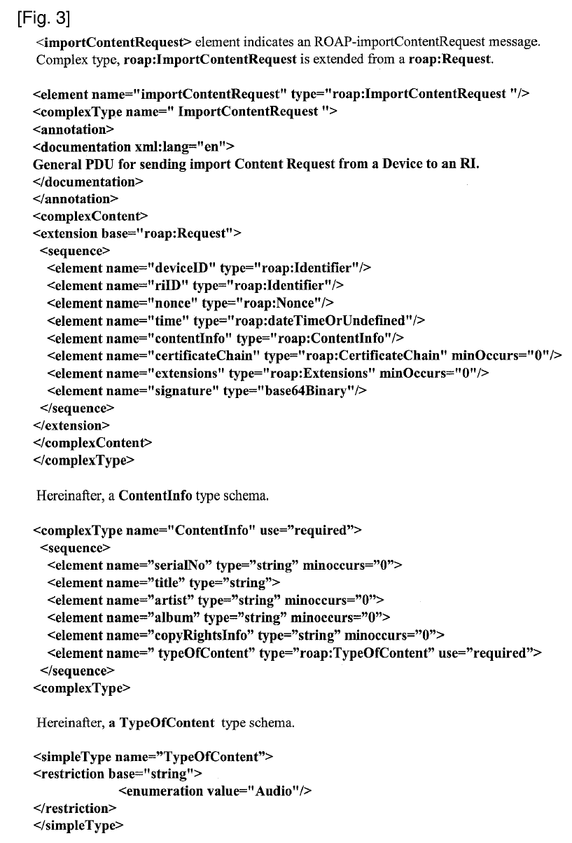

FIG. 2 is a configuration view schematically showing an operation of a device for protecting unprotected contents;

FIG. 3 is an XML schema of an <ImportContent-Request>;

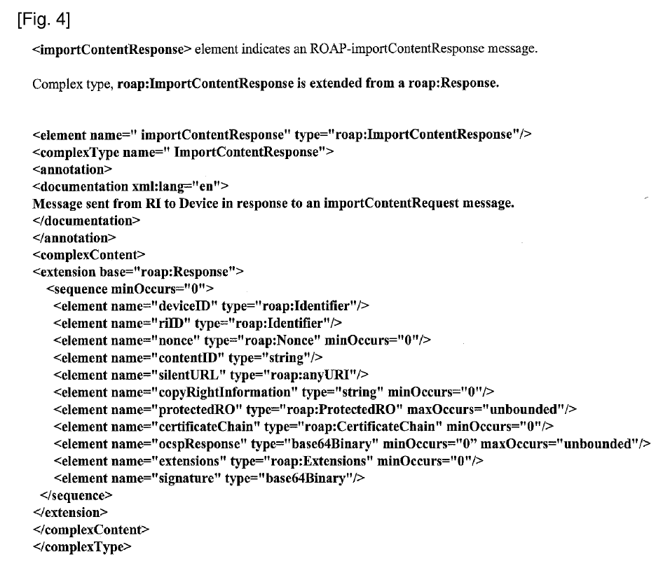

FIG. 4 an XML schema of an <ImportContent-Response>;

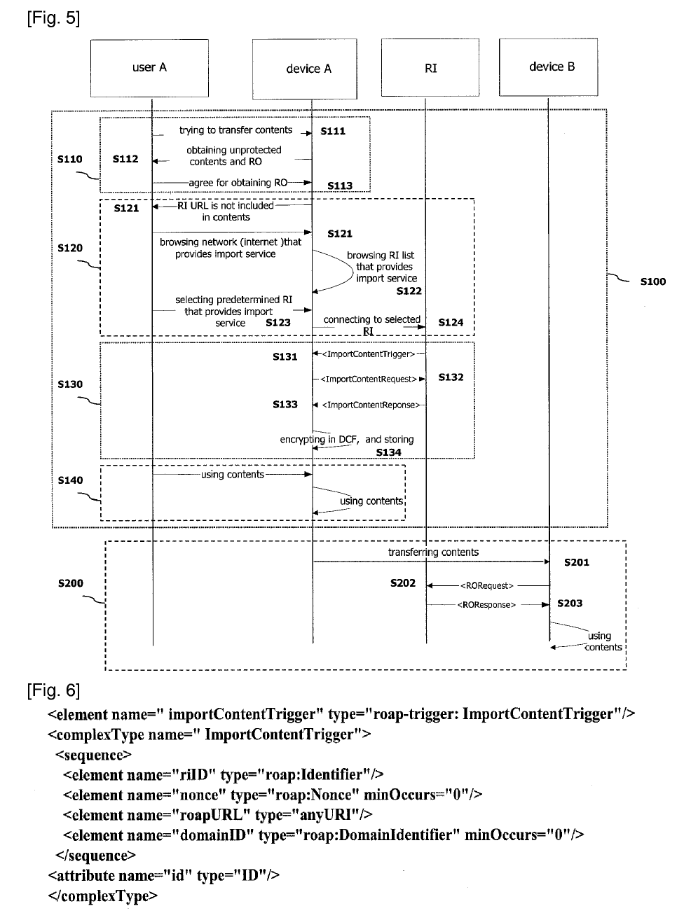

FIG. 5 is a flowchart showing a method for making (converting) unprotected contents into protected contents; and

FIG. 6 is an XML schema of an <ImportContentTrigger>.

Reference will now be made in detail to the preferred embodiments of this disclosure, examples of which are illustrated in the accompanying drawings.

Hereinafter, a method for protecting unprotected contents in a DRM and a device thereof will be explained in more detail. Preferred embodiment of this disclosure is specified in an OMA-DRM 2.0 specification.

In this disclosure, unprotected contents stored in a non-DRM device are converted into protected contents so as to be transferred to a DRM device, and then are transferred to other user's device.

FIG. 2 is a configuration view schematically showing an operation of a device for protecting unprotected contents.

Referring to FIG. 2, in order to convert (make or change) unprotected contents stored in a non-DRM device (e.g, a media player of FIG. 2) into protected contents, a user A of a DRM device requests (ImportRequest) specific information to encode the unprotected contents from an RI. Then, the DRM device converts (make, or change) the unprotected contents into protected contents (DRM contents) by using the specific information. Converting the unprotected contents into the protected contents is called as an ‘import service’.

The converted contents (i.e., contents converted into the protected, hereinafter it is referred as ‘converted protected-contents’) are transferred to other user (i.e., a user B of FIG. 2). In order for the user B to consume the protected contents, the user B requests a rights object (RO) from the RI (RO Request). After receiving a response for the RO request, the user B can consume the protected contents.

In order to convert unprotected contents into protected contents, a new message has to be defined in an ROAP protocol between the user A's device and the RI, and a series of processes are performed through the new message.

Hereinafter, a new message defined in an ROAP protocol between the user A's device and the RI will be explained.

The newly-defined message includes an <ImportContentRequest> and an < ImportCountentReseponse>. The <ImportContentRequest> is a message sent to the RI from a predetermined device (i.e., the user A's device in FIG. 2), and an XML schema of the <ImportContentRequest> is shown in FIG. 3. The <ImportContentResponse> is a message sent to a predetermined device (i.e., the user A's device in FIG. 2) from the RI, and an XML schema of the <ImportContentResponse> is shown in FIG. 4. Herein, the predetermined device (e.g, the user A's device in FIG. 2) serves to convert unprotected contents stored in other device (e.g, a media player of FIG. 2) into protected contents.

The newly-defined messages include one or more parameters (fields). The parameters are used to convert unprotected contents into protected contents. Hereinafter, the parameters will be explained in more detail. It is assumed that the unprotected contents correspond to a specific artist's disc.

One of the newly-defined messages, the <ImportContentRequest> includes a serial number, an artist name, an album name, copyright information (corresponding to purchased contents), etc.

One of the newly-defined messages, the <ImportContentResponse> includes a contents-ID, a contents encryption key (CEK), a rights object (RO), copyright information for contents (when the RI possesses specific contents), a Silent-Header URL, etc. Herein, the Silent-Header URL is a URL of an RI server to which a DRM Agent (mounted on a user's device) is connected for obtaining (fetching, or retrieving) RO.

The DRM Agent converts unprotected contents into protected contents by using information included in the newly-defined message (parameter) in a digital content format (DCF), and then stores them in a predetermined unit (e.g., a memory). The DRM Agent converts unprotected contents into an OMA DRM content format (DCF) by using predetermined algorithms.

The user A transfers the protected contents to the user B (super-distribution). After the user B's device receives the protected contents, a DRM Agent of the user B's device extracts a URL from a ‘Silent-Header’ parameter (field) of the DCF. Then, the DRM Agent is connected to the RI through the extracted URL. As disclosed in the DRM 2.0 specification, the DRM Agent of the user B's device requests RO from the RI thus to receive the requested RO.

FIG. 5 is a flowchart showing a method for converting unprotected contents into protected contents, in which a URL of the RI server is not included in contents purchased by the user A (unprotected contents).

Referring to FIG. 5, the method for protecting unprotected contents in a DRM comprises converting contents purchased by the user A (unprotected contents) into protected contents (i.e., DRM contents) (S100), and transferring (copying) the converted protected-contents to other DRM device from a device A by the user A (S200).

The step S100 includes precedent operations between user A and device A in order to transfer the non-protected contents (e.g., an audio CD) purchased by the user A from a non-DRM device (e.g., an audio CD player) to the device A (S110), selecting an RI server to provide an import service so as to convert the purchased unprotected contents into protected contents (S120), receiving an import service from the selected RI server by a DRM Agent (not shown) mounted on the device A, and thus converting the unprotected contents into protected contents (S130), and consuming (using, or rendering, or reproducing, or playing back) the protected contents having been converted through the steps S110 to S130.

Hereinafter, a method for converting unprotected contents into protected contents will be explained with reference to FIG. 5.

While playing back (using, or rendering) unprotected contents (i.e., an audio CD) purchased online or off-line on a non-DRM device (i.e., an audio CD player), a user A may want to transfer (move, or copy, or send) the purchased contents (unprotected contents) from the non-DRM device to a device A (i.e., a DRM device of the user A) (S100). That is, the user A may try to transfer the purchased unprotected-contents into the device A from the non-DRM device by connecting the non-DRM device with the device A each other by a predetermined interface (i.e., a USB cable) (S111).

A DRM Agent (not shown) mounted on (equipped with) the device A checks whether the purchased unprotected-contents are protected by a DRM. If it is determined (recognized) that the purchased contents are not protected by the DRM, the DRM Agent may prompt to the user A that the purchased contents are not protected by the DRM and may not be allowed to be transferred, and then may prompt the user A to convert the unprotected contents into protected contents and to obtain a rights object (RO) for the contents (S112).

Then, if the user A consents (decides, or desires) to obtain the RO (S113), the DRM Agent may convert (make, or change) the unprotected contents into protected contents and may obtain the RO. Herein, the DRM Agent of the device A may extract an RI URL from the unprotected contents, connect to an RI server through the RI URL, and perform an import service process for converting the unprotected contents into protected contents (i.e., DRM contents). However, if the RI URL is not included in the unprotected contents, the DRM Agent of the device A may have to perform a process for selecting an RI server to receive the import service (S120).

That is, if the RI URL is not included in the unprotected contents, the DRM Agent of the device A may inform the user A of this (S121). Then, the user A may connect to a network (e.g., the internet) through the device A (S122), and browse a list of an RI portal server that provides an import service for converting the unprotected contents into protected contents (S123). The network may provide one or more URLs each of which corresponds to each RI portal server, and the each RI portal server may provide an import service.

Once the user A selects a specific RI server that provides an import service through the steps S122 and S123, the DRM Agent of the device A may be connected to the selected RI server (S124 and S125).

Next to step S121, the device A may select a specific RI from one or more RIs to which it has been registered, and may connect to the selected RI for an import service (not shown).

Next to steps S110 and S120, the device A may receive an import service from the connected RI (S130). Hereinafter, the step S130 will be explained in more detail.

The DRM Agent connected to the RI may receive an <ImportContentTrigger> message from the RI (S131). Once receiving the <ImportContentTrigger> message, the DRM Agent may start to perform an import operation (S132 and S133). Herein, the <ImportContentsTrigger> may be a trigger newly-proposed in the present invention, and an XML schema of the <ImportContentTrigger> may be shown in FIG. 6.

The DRM Agent having received the <ImportContentTrigger> may extract contents information such as a serial number, an album, and an artist from the purchased contents (i.e., an audio CD), and then may transfer the information to the RI with including in a predetermined request message (i.e., ImportContentRequest) (S132).

After receiving the request message, the RI returns information (i.e., a CEK, a contents ID, an RO, copy right information for contents, a Silent-Header URL, etc.) to the DRM Agent with including in a predetermined response message (e.g., ImportContentResponse) (S133).

Then, the DRM Agent encrypts the unprotected contents purchased by the user A. That is, the DRM Agent encrypts (converts) the unprotected contents into a DRM DCF (digital content format), and then stores the encrypted contents into a predetermined storage unit (e.g., a memory equipped with the device A) (S134).

Once step S134 is successfully performed, the user A can access (consume, or use, or render) to the encrypted contents by using the RO obtained in the step S133 (i.e., the RO returned to the DRM Agent of the device A with being included in the < ImportContentResponse> message. Accordingly, the user A can consume (use, or render) the encrypted contents in its DRM device (the device A) like other DRM contents (S140).

If an RO for a unprotected content is issued to the device A, the RI prevents an <ImportContentRequest> message having the same serial number as the unprotected content's serial number from approaching to the RI, thereby not allowing the same RO for one content to be repeatedly issued (i.e., a RO for one content may be issued only one times by the RI).

As such, the RI may issue contents with encryption (i.e., protected contents converted from unprotected contents) to one predetermined DRM device. In addition, the RI may issue the encrypted contents (i.e., protected contents) to the device A join in a certain domain so that an RO can be shared together with other DRM devices joined in the certain domain. The RO is called as a domain rights object (domain RO) for DRM contents, and is issued by the RI according to a request of the user's device. The domain RO can be shared together with a plurality of devices that belong to the same domain. Accordingly, other DRM devices joined to the certain domain having received the domain RO (device B of FIG. 5) needs not perform a normal 2 pass RO-Acquisition protocol for obtaining the RO

The user A may transfer (distribute) the protected contents (i.e., DRM contents converted from the unprotected contents) to one or more other DRM devices (e.g., device B) from the device A (S200), which is called as a ‘super-distribution’. That is, the user A transfers the protected contents to other DRM device (the device B) from the device A (S201). Once receiving the protected contents (super-distributed contents), a DRM Agent of the device B (not shown in FIG. 5) may extract a URL from a Silent-Headers field in a DCF, and then accesses to the RI through the extracted URL. Then, a normal 2 pass RO-Acquisition protocol for obtaining RO may be performed between the DRM Agent of the device B and the RI. That is, if the DRM Agent of the device B requests an RO to the RI through an RO Request message (S202), the RI sends the RO to the DRM Agent of the device B through an RO Response message (S203). Accordingly, a user of the device B can use (consume, or render, or play back, or reproduce) the protected contents received in step S201 by using the RO obtained in step S203.

In this disclosure, unprotected contents are converted into protected contents. Especially, even if unprotected contents do not include a predetermined RI URL, the unprotected contents can be converted into protected contents by selecting a predetermined RI server that provides an import service.

Furthermore, in this disclosure, unprotected contents can be prevented from being distributed at random, and prevented from being illegally copied.

Besides, in this disclosure, a contents library can be implemented by converting unprotected contents into protected contents, in which the converted contents can be shared together with other devices joined in a domain) and be shared for a specific group or family selected by a user.

It will also be apparent to those skilled in the art that various modifications and variations can be made in this disclosure without departing from the spirit or scope of the invention. Thus, it is intended that this disclosure cover modifications and variations of this disclosure provided they come within the scope of the appended claims and their equivalents.

1. A method for protecting unprotected content, comprising:
extracting information from first content stored in a first device by a second device;
checking whether an RI URL is included in the extracted information by the second device; and
selecting a specific RI and connecting thereto by the second device, if the RI URL is not included in the information.

2. The method of claim 1, wherein the first content is unprotected content, and the first device is a digital rights management (DRM) device.

3. The method of claim 1, wherein the second device is a DRM device.

4. The method of claim 1, wherein the specific RI is selected by the second device from one or more RIs to which the second device has been registered.

5. The method of claim 1, wherein the selecting includes:
connecting to a specific network by the second device;
searching an RI URL list provided from the specific network;
selecting a specific RI URL from the RI URL list by a user of the second device; and
connecting to an RI corresponding to the selected specific RI URL by the second device.

6. The method of claim 5, wherein the specific network provides an import service.

7. The method of claim 1, wherein if the RI URL is included in the information extracted from the first content, connecting to an RI corresponding to the extracted RI RUL by the second device.

8. The method of claim 1, further comprising converting the first content into second content.

9. The method of claim 8, wherein the second content are created by encrypting the first content, and are protected by a DRM.

10. The method of claim 8, wherein the converting the first content into second content includes:
receiving a trigger message from the RI by the second device;
sending a request message for encoding the first content to the RI by the second device;
sending a response message to the second device by the RI; and
converting the first content into second content by using specific information
included in the response message by the second device.

11. The method of claim 10, further comprising storing the second content in a predetermined storage unit by the second device.

12. The method of claim 10, wherein the request message is predetermined information for encoding the unprotected content, and includes one or more copyright information for the unprotected content.

13. The method of claim 10, wherein the response message is predetermined information for encoding the unprotected content, and includes one or more specific information.

14. The method of claim 13, wherein the specific information includes at least a content encryption key (CEK), a content ID, and a rights object.

15. The method of claim 1, further comprising sending the second content to a third device by the second device.

16. The method of claim 15, wherein the third device is a DRM device.

17. The method of claim 15, wherein the second device and the third device belong to the same domain, and share the second content.

18. A device for protecting unprotected content in a DRM, in which whether or not content received from a specific device are protected content is checked, and if the received content are not protected content, the device is connected to a specific network so as to convert the received content into protected content.

19. The device of claim 18, wherein the device informs a user that the received content are not protected content, if the received content are not protected content.

20. The device of claim 18, wherein the specific network provides an import service.

21. The device of claim 18, wherein the device receives an RI list provided from the specific network.

22. The device of claim 21, wherein the device is connected to a specific RI selected by a user from the RI list.

23. The device of claim 22, wherein predetermined information about the content is sent to the RI so as to convert the received content into protected content.

24. The device of claim 23, wherein the predetermined information about the content is sent to the RI with being included in a predetermined request message.

25. The device of claim 18, wherein the received content are converted into protected content by using predetermined information sent from the connected specific RI.

26. The device of claim 25, wherein the predetermined information is sent from the RI with being included in a response message.

27. The device of claim 25, wherein the specific information includes a content encryption key (CEK), a content ID, a rights object, and a Silent-Header URL.

28. The device of claim 27, wherein the received content are converted into protected content by being encrypted by the CEK.

29. The device of claim 28, wherein the converted content into protected content are stored.

30. The device of claim 28, wherein the converted content into protected content are transferred to other device.
